(19) United States
(12) Patent Application Publication
(10) Pub. No.: US 2024/0389158 A1
(43) Pub. Date: Nov. 21, 2024

(54) GROUP RANDOM ACCESS

(71) Applicants: Amit KALHAN, San Diego, CA (US); Kyocera Corporation, Kyoto (JP)

(72) Inventor: Amit KALHAN, San Diego, CA (US)

(21) Appl. No.: 18/687,395

(22) PCT Filed: Sep. 29, 2022
(86) PCT No.: PCT/US2022/045160

§ 371 Date: Feb. 28, 2024

Related U.S. Application Data
(60) Provisional application No. 63/250,411, filed on Sep. 30, 2021.

(51) Int. Cl. H04W 74/0833; H04L 5/14

(52) U.S. Cl. CPC H04W 74/0833; H04L 5/14

(57) ABSTRACT

The devices, systems, and methods discussed herein reduce the time for user equipment (UE) devices to acquire synchronization by having a base station transmit, on a Physical Downlink Shared Channel (PDSCH), a synchronization signal to a UE device at a pre-determined first time interval before a time-slot in which Random Access Channel (RACK) uplink transmissions are transmitted, where the synchronization signal comprises a plurality of copies of a sequence. In further examples, the base station transmits, to the UE device prior to the UE device entering a sleep state, at least one message containing one or more synchronization signal parameters for the synchronization signal. In still further examples, the base station transmits the synchronization signal during a second time interval that begins at a projected wake-up time for the UE device.

### CLAIM OF PRIORITY

The present application claims priority to U.S. Provisional Application No. 63/250,411, entitled “Group Random Access,” docket number TPRO 00365 US, filed Sep. 30, 2021, which is assigned to the assignee hereof and hereby expressly incorporated by reference in its entirety.

### FIELD

This invention generally relates to wireless communications and more particularly to synchronization of user equipment devices.

### BACKGROUND

In a wireless network, the mobile device or user equipment (UE) device is required to maintain an accurate symbol timing synchronization with the serving base station. The network synchronization is needed to correctly decode the received downlink signals transmitted from the base station and to perform uplink transmissions to the base station.

### SUMMARY

The devices, systems, and methods discussed herein reduce the time for user equipment (UE) devices to acquire synchronization by having a base station transmit, on a Physical Downlink Shared Channel (PDSCH), a synchronization signal to a UE device at a pre-determined first time interval before a time-slot in which Random Access Channel (RACH) uplink transmissions are transmitted, where the synchronization signal comprises a plurality of copies of a sequence. In further examples, the base station transmits, to the UE device prior to the UE device entering a sleep state, at least one message containing one or more synchronization signal parameters for the synchronization signal. In still further examples, the base station transmits the synchronization signal during a second time interval that begins at a projected wake-up time for the UE device.

### BRIEF DESCRIPTION OF THE DRAWINGS

FIG. 1 is a messaging diagram of an example in which a base station and a user equipment (UE) device exchange messages to facilitate the UE device acquiring synchronization upon waking from a sleep state.

FIG. 2A is a block diagram of an example of the base station shown in FIG. 1.

FIG. 2B is a block diagram of an example of the user equipment device shown in FIG. 1.

FIG. 3 is an example of a Time Division Duplex (TDD) deployment in which a synchronization signal block is transmitted at a predetermined first time interval before a time-slot in which RACH uplink transmissions are transmitted.

FIG. 4 is an example of a Frequency Division Duplex (FDD) deployment in which a synchronization signal block is transmitted at a predetermined first time interval before a time-slot in which RACH uplink transmissions are transmitted.

FIG. 5 is a flowchart of an example of a method in which a base station transmits synchronization signal parameters to a UE device before the UE device enters a sleep state. The base station transmits a synchronization signal to the UE device at a predetermined first time interval before a time-slot in which RACH uplink transmissions are transmitted.

### DETAILED DESCRIPTION

As mentioned above, network synchronization is needed by user equipment (UE) devices to correctly decode the received downlink signals transmitted from the base station. To this end, the UE devices listen to the serving base station's synchronization signal, which is referred to as the primary synchronization signal/secondary synchronization signal (PSS/SSS) in systems that operate in accordance with the Long-Term Evolution (LTE) standard or the 5G New Radio (5G NR) standard. The UE devices use the PSS/SSS to adjust their internal clocks to track the symbol, time-slot, and frame time boundaries.

In order to save power (e.g., battery power and/or stored energy), the UE devices periodically turn OFF their transceivers to go into a sleep state. The UE devices periodically wake-up from the sleep state to check whether a page message was received from the base station or for an uplink transmission. If a UE device receives a page message, then the UE device stays ON to receive the subsequent control and data signals.

Obviously, the longer the UE device stays asleep, the greater the UE device reduces its battery-consumption. However, there is a drawback of a long duration sleep state in that the internal clock of the UE device drifts away from the nominal timing value while in the sleep state. Therefore, every time a UE device wakes up, it has to reacquire the symbol timing.

Similarly, when a data packet arrives from higher layers for an uplink transmission, a UE device must wake up to access the network. After waking up, the UE device turns ON its transceiver, acquires timing by successfully receiving the downlink synchronization channel, and then waits for the Random Access Channel (RACH) resources to perform a Random Access (RA) procedure.

In both the paging reception and the uplink data transmission, the resynchronization time becomes a much larger overhead. To achieve a long battery-life, the UE devices may have a much longer sleep-cycle on the order of several minutes and, in some cases, on the order of several hours. Specifically, with extended Discontinuous Reception (eDRX), the Discontinuous Reception (DRX) cycle is extended up to and beyond 10.24 seconds in idle mode, with a maximum value of 2621.44 seconds (43.69 minutes). Such a long sleep results in much larger clock-drifts for the UE devices. In poor coverage scenarios, the received signal strength could be as low as a signal-to-noise ratio (SNR)=−14 dB.

Having a large clock-drift and receiving a downlink signal at very low signal strength force the UE devices to take several hundreds of milliseconds to acquire the network timing. The reason it takes such a long time to detect the correct timing is that the UE devices have to wait to receive and accumulate multiple repetitions of the synchronization signal for coherently combining in order to achieve a higher SNR. For example, in the existing LTE, a UE device acquiring synchronization would require almost 400 ms=80 PSS/SSS subframes with PSS/SSS transmitted every 5 ms. For example, to meet the 10% block error rate (BLER) with 5% timing offset error, a UE device must capture 76 copies of PSS/SSS. To capture 76 copies of the PSS/SSS, it takes the UE device 380 ms for resynchronization since each PSS/SSS transmission occurs with a periodicity of 5 ms.

This delay is worse in 5G NR if the operators configure the Synchronization Signal Block (SSB) transmission periodicity to a larger value, which ranges from 5 ms to 160 ms. One possibility is to broadcast the SSB with a much shorter time-period. However, this would have a very large overhead since not all UE devices within the cell need to acquire resynchronization at a given time. Additionally, the transmission of the SSB is overkill for the purpose of resynchronization because the SSB is designed to provide not just the timing information but also other information. Therefore, there is a need to reduce the time to acquire synchronization.

The devices, systems, and methods discussed herein reduce the time for user equipment (UE) devices to acquire synchronization by having a base station transmit, on a Physical Downlink Shared Channel (PDSCH), a synchronization signal to a UE device at a pre-determined (e.g., which may also be considered as “configured,” “preconfigured,” or “scheduled”) first time interval before a time-slot in which Random Access Channel (RACH) uplink transmissions are transmitted, where the synchronization signal comprises a plurality of copies of a sequence. In further examples, the base station transmits, to the UE device prior to the UE device entering a sleep state, at least one message containing one or more synchronization signal parameters for the synchronization signal. In still further examples, the base station transmits the synchronization signal during a second time interval that begins at a projected wake-up time for the UE device.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

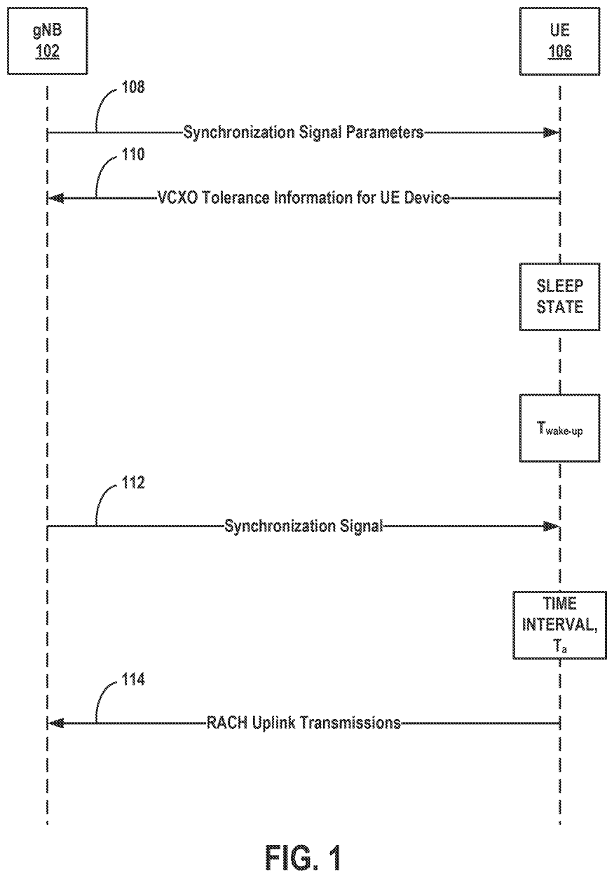

FIG. 1 is a messaging diagram of an example of a system in which a base station and a user equipment (UE) device exchange messages to facilitate the UE device acquiring synchronization upon waking from a sleep state. For the example shown in FIG. 1, only a single base station 102 and a single UE device 106 are shown. However, any number of base stations and UE devices may be included in other examples.

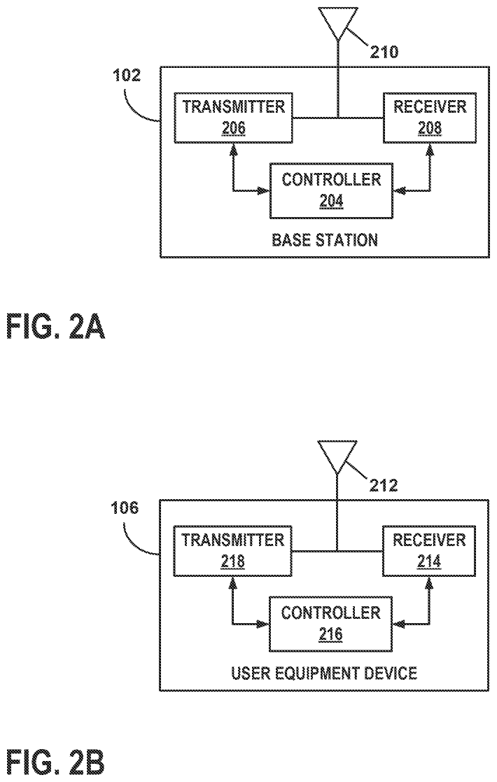

FIG. 2A is a block diagram of an example of the base station shown in FIG. 1. In the example of FIG. 1, base station 102 provides wireless services to UEs within a coverage area provided by base station 102. Although not explicitly shown in FIG. 1, the coverage area provided by base station 102 may be comprised of multiple cells. For the example shown in FIG. 1, base station 102, sometimes referred to as a gNodeB or gNB, can receive uplink messages from UE devices and can transmit downlink messages to the UE devices.

Base station 102 is connected to the network through a backhaul (not shown) in accordance with known techniques. As shown in FIG. 2A, base station 102 comprises controller 204, transmitter 206, receiver 208, and antenna 210 as well as other electronics, hardware, and code. Base station 102 is any fixed, mobile, or portable equipment that performs the functions described herein. The various functions and operations of the blocks described with reference to base station 102 may be implemented in any number of devices, circuits, or elements. Two or more of the functional blocks may be integrated in a single device, and the functions described as performed in any single device may be implemented over several devices.

For the example shown in FIG. 2A, base station 102 may be a fixed device or apparatus that is installed at a particular location at the time of system deployment. Examples of such equipment include fixed base stations or fixed transceiver stations. In some situations, base station 102 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, base station 102 may be a portable device that is not fixed to any particular location. Accordingly, base station 102 may be a portable user device such as a UE device in some circumstances.

Controller 204 includes any combination of hardware, software, and/or firmware for executing the functions described herein as well as facilitating the overall functionality of base station 102. An example of a suitable controller 204 includes code running on a microprocessor or processor arrangement connected to memory. Transmitter 206 includes electronics configured to transmit wireless signals. In some situations, transmitter 206 may include multiple transmitters. Receiver 208 includes electronics configured to receive wireless signals. In some situations, receiver 208 may include multiple receivers. Receiver 208 and transmitter 206 receive and transmit signals, respectively, through antenna 210. Antenna 210 may include separate transmit and receive antennas. In some circumstances, antenna 210 may include multiple transmit and receive antennas.

Transmitter 206 and receiver 208 in the example of FIG. 2A perform radio frequency (RF) processing including modulation and demodulation. Receiver 208, therefore, may include components such as low noise amplifiers (LNAs) and filters. Transmitter 206 may include filters and amplifiers. Other components may include isolators, matching circuits, and other RF components. These components in combination or cooperation with other components perform the base station functions. The required components may depend on the particular functionality required by the base station.

Transmitter 206 includes a modulator (not shown), and receiver 208 includes a demodulator (not shown). The modulator modulates the signals that will be transmitted and can apply any one of a plurality of modulation orders. The demodulator demodulates any uplink signals received at base station 102 in accordance with one of a plurality of modulation orders.

FIG. 2B is a block diagram of an example of the user equipment device shown in FIG. 1. As shown in FIG. 2B, user equipment device (UE) 106 comprises controller 216, transmitter 218, receiver 214, and antenna 212, as well as other electronics, hardware, and software code. UE device 106 may also be referred to herein as a UE or as a wireless communication device (WCD). UE 106 is wirelessly connected to a radio access network (not shown) via base station 102, which provides various wireless services to UE 106. For the example shown in FIG. 1, UE 106 operates in accordance with at least one revision of the 3rd Generation Partnership Project 5G New Radio (3GPP 5G NR) communication specification. In other examples, UE 106 may operate in accordance with other communication specifications. For the example shown in FIG. 1, UE 106 has the components, circuitry, and configuration shown in FIG. 2B. However, UE 106 may have components, circuitry, and configuration that differ from that shown in FIG. 2B, in other examples.

UE 106 is any fixed, mobile, or portable equipment that performs the functions described herein. The various functions and operations of the blocks described with reference to UE 106 may be implemented in any number of devices, circuits, or elements. Two or more of the functional blocks may be integrated in a single device, and the functions described as performed in any single device may be implemented over several devices.

Controller 216 includes any combination of hardware, software, and/or firmware for executing the functions described herein as well as facilitating the overall functionality of a user equipment device. An example of a suitable controller 216 includes software code running on a microprocessor or processor arrangement connected to memory. Transmitter 218 includes electronics configured to transmit wireless signals. In some situations, transmitter 218 may include multiple transmitters. Receiver 214 includes electronics configured to receive wireless signals. In some situations, receiver 214 may include multiple receivers. Receiver 214 and transmitter 218 receive and transmit signals, respectively, through antenna 212. Antenna 212 may include separate transmit and receive antennas. In some circumstances, antenna 212 may include multiple transmit and receive antennas.

Transmitter 218 and receiver 214 in the example of FIG. 2B perform radio frequency (RF) processing including modulation and demodulation. Receiver 214, therefore, may include components such as low noise amplifiers (LNAs) and filters. Transmitter 218 may include filters and amplifiers. Other components may include isolators, matching circuits, and other RF components. These components in combination or cooperation with other components perform the user equipment device functions. The required components may depend on the particular functionality required by the user equipment device.

Transmitter 218 includes a modulator (not shown), and receiver 214 includes a demodulator (not shown). The modulator can apply any one of a plurality of modulation orders to modulate the signals to be transmitted by transmitter 218. The demodulator demodulates received signals, in accordance with one of a plurality of modulation orders.

In operation, base station 102 of FIG. 1 transmits a synchronization signal before the upcoming Random Access Channel (RACH) resources for a group of UE devices interested in accessing the network for their subsequent data uplink transmissions. In the example shown in FIG. 1, base station 102 transmits, to UE device 106 prior to UE device 106 entering a sleep state, at least one message (via signal 108) containing one or more synchronization signal parameters for a synchronization signal. In some examples, the synchronization signal parameters may include M, N, a Time Interval (Tₐ), location(s) of the synchronization signal in the time-frequency domain, the sequence-length, sequence assignment, etc., which are configured by base station 102 and conveyed to UE device 106 before UE device 106 enters a sleep state.

In some examples, the one or more synchronization signal parameters are transmitted in one or more dedicated Radio Resource Control (RRC) messages. In other examples, the one or more synchronization signal parameters are transmitted via Media Access Control (MAC) Control Element (CE) signaling. In further examples, the one or more synchronization signal parameters can be pre-configured, provided during registration of the UE device, part of the system information transmitted in System Information Block (SIB) messaging, etc.

In some examples, base station 102 utilizes antenna 210 and receiver 208 to receive a UE capability message containing Voltage-Controlled Crystal Oscillator (VCXO) tolerance information for UE device 106. In the example shown in FIG. 1, the UE capability message containing VCXO tolerance information for UE device 106 is sent via signal 110. In some examples, base station 102 utilizes controller 204 to schedule transmission of the synchronization signal based, at least partially, on the VCXO tolerance information for UE device 106.

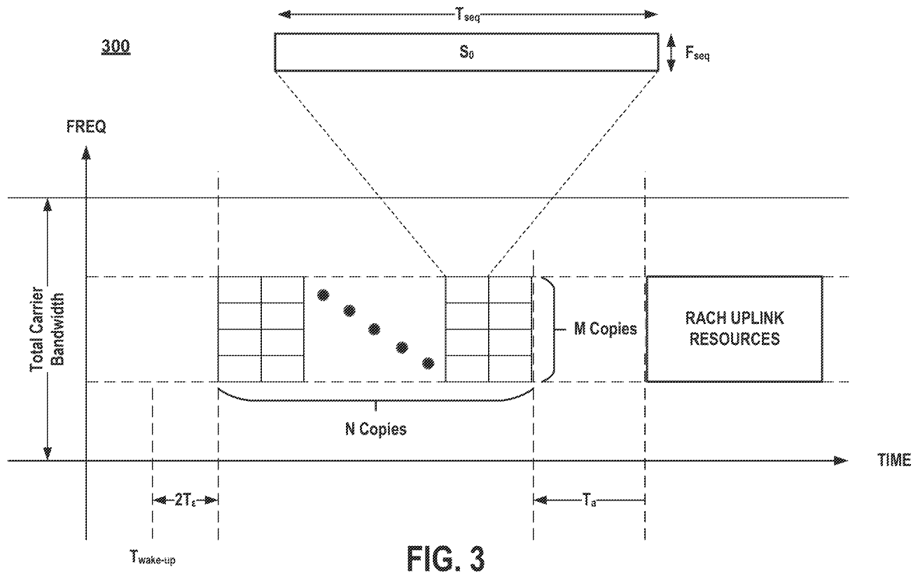

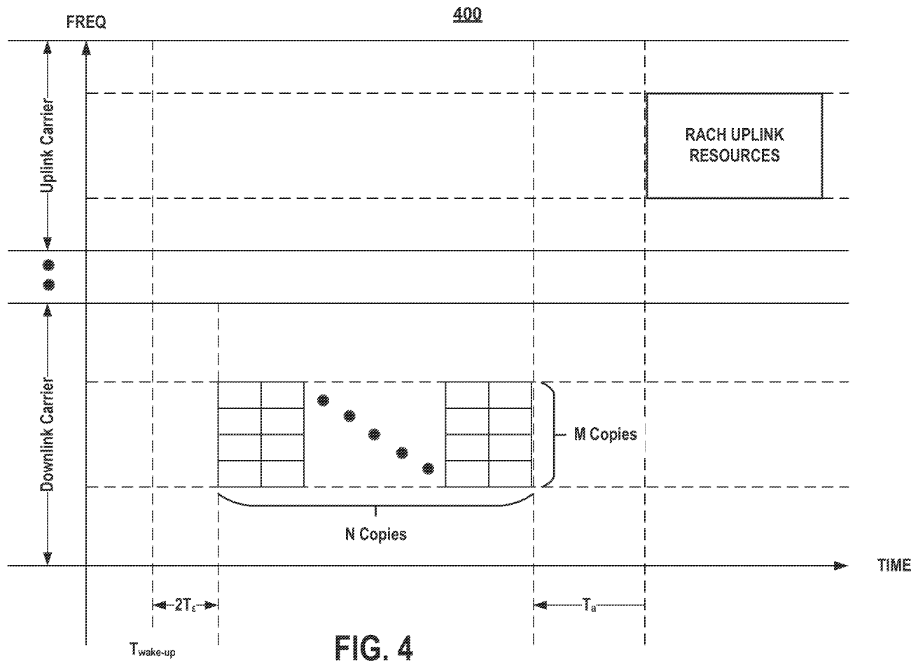

In some examples, base station 102 utilizes controller 204 to determine a projected wake-up time, T_{wake-up}, for UE device 106 and begins transmitting, via transmitter 206 and antenna 210, the synchronization signal during a time interval that begins at the projected wake-up time. This time interval, which begins at T_{wake-up}, lasts for a period of time that is based, at least partially, on a clock-drift error value, T_{ϵ}, associated with UE device 106, in some examples. This time interval, which is based at least partially on the projected wake-up time, for beginning to transmit the synchronization signal is discussed more fully below in connection with FIGS. 3 and 4.

In the example shown in FIG. 1, base station 102 transmits, on a Physical Downlink Shared Channel (PDSCH), a synchronization signal to UE device 106, which is represented by signal 112. In some examples, the synchronization signal is transmitted at a pre-determined time interval, Tₐ, before a time-slot in which RACH uplink transmissions are transmitted. Stated differently, transmission of the synchronization signal is completed by the beginning of the time interval, Tₐ, which is discussed more fully below.

In some examples, the synchronization signal comprises a plurality of copies of a sequence. In the example shown in FIG. 1, base station 102 transmits, via transmitter 206 and antenna 210, M×N copies of the sequence, where M represents a first number of copies of the sequence spread across at least a portion of downlink frequency resources utilized to transmit the synchronization signal and N represents a second number of copies of the sequence spread across at least a portion of downlink time resources utilized to transmit the synchronization signal. In some examples, base station 102 uses controller 204 to determine M and N based on at least one of the following: carrier bandwidth availability, a Coverage Enhancement (CE) level, a received downlink signal quality or strength reported by UE device 106, and a VCXO tolerance of UE device 106. The copies of the sequence are collectively referred to herein as the synchronization signal block.

In some examples, base station 102 and UE device 106 operate in accordance with a Time Division Duplex (TDD) deployment in which downlink resources and uplink resources are located on a same carrier. An example of a TDD deployment is shown in FIG. 3. In other examples, base station 102 and UE device 106 operate in accordance with a Frequency Division Duplex (FDD) deployment in which downlink resources are located on a downlink carrier and uplink resources are located on an uplink carrier. An example of an FDD deployment is shown in FIG. 4.

FIG. 3 is an example of a Time Division Duplex (TDD) deployment 300 in which a synchronization signal block is transmitted at a predetermined first time interval, Tₐ, before a time-slot in which RACH uplink transmissions are transmitted. In a TDD deployment situation, the downlink and the uplink resources occur on the same carrier but at different times. As shown in the example of FIG. 3, base station 102 transmits a synchronization signal block comprising M×N copies of the same sequence, S₀, such that all of the copies of the sequence are transmitted by the beginning of a predetermined time interval, Tₐ, before the start of the RACH uplink resources.

The copies of the sequence may or may not be allocated in consecutive resources. In some examples, each copy is spread out in frequency and time to achieve greater frequency and time diversity, respectively. In further examples, a sequence, S₀, spans over a long period of time, providing much greater cross-correlation properties to achieve higher successful detection rate by UE device 106. In examples in which the copies of the sequence are not allocated in consecutive resources, data for the UE devices may occupy the time-frequency resources of the PDSCH that are interspersed between the non-consecutive resources that are occupied by the copies of the sequence.

In some examples, base station 102 anticipates the wake-up time of the UEs and schedules the transmission of the synchronization signal block ahead of the upcoming RACH resources. In the example of FIG. 3, each sequence, S₀, has a size of T_{seq}×F_{seq} time-frequency resources. One advantage of the example of FIG. 3 is that all of the copies of the sequence are transmitted in a short-period of time, giving the opportunity to the UEs to acquire resynchronization much faster, resulting in a significantly reduced ON time for the UE devices. For the TDD deployments, base station 102 schedules (1) the synchronization signal block in the time-frequency resources, and (2) the starting point for transmitting the synchronization signal block after taking into consideration the UE's VCXO tolerance. In some examples, UE device 106 must receive all of the M×N copies of the sequence contained in the synchronization signal block to achieve successful detection.

In some examples, the scheduling of the synchronization signal block is similar to the transmission of a data packet to a UE except that it is “pre-determined.” For example, the location of the synchronization signal block relative to the RACH resources allows UE device 106 to determine the subframe number within a frame upon successful detection. As shown in FIG. 3, the end of the synchronization signal block is transmitted at a time interval, Tₐ, ahead of the upcoming RACH resources, which is known to UE device 106. This predetermined time interval, Tₐ, helps the UEs determine the frame timing when the UEs wake-up without the knowledge of the subframe boundary locations.

As mentioned above, the parameters such as M, N, the time interval (Tₐ), location(s) of the synchronization signal in the frequency domain, the sequence-length, sequence assignment, etc. are configured by base station 102 and conveyed to UE device 106 before UE device 106 enters a sleep state, in some examples. In further examples, the parameters M and N are adjusted for each UE (or UE group) according to its operational carrier-bandwidth, Coverage Enhancement level, and VCXO tolerance.

For the example shown in FIG. 3, it is assumed that UE device 106 has a clock-drift error value of ±T_{ϵ} and that base station 102 has the flexibility to transmit the synchronization signal block anytime within a time interval starting at T_{wake-up}. As mentioned above, this time interval, which begins at T_{wake-up}, lasts for a period of time that is based, at least partially, on a clock-drift error value, T_{ϵ}, associated with UE device 106, in some examples. In the example shown in FIG. 3, the time interval begins at T_{wake-up} and lasts for a duration of 2T_{ϵ}. However, the time interval that begins at T_{wake-up}may have any suitable duration, in other examples. In some examples, by default, base station 102 assumes that T_{ϵ}=0 since the UEs are capable of adjusting for their clock-drift error.

In some examples, a system that operates in accordance with the 5G NR standard is preferred since it has a much more flexible slot-structure design compared to LTE/LTE-A. In 5G NR, each time-slot consists of 14 orthogonal frequency-division multiplexing (OFDM) symbols. In this design, the base station does not transmit on a physical downlink control channel (PDCCH) and allocates the whole time-slot for PDSCH transmission.

In some examples, the slot format 0 consists of all 14 normal-CP (cyclic prefix) downlink symbols with 15 kHz subcarrier spacing. A Resource Element (RE) size is 1 subcarrier×1 symbol, and the minimum unit of allocation spans 12 subcarriers×14 symbols equal to 168 REs. Assuming a K-length ZC sequence (Zadoff-Chu sequence) would require K numbers of REs in a time-slot, then for the 63-length ZC sequence there are several possible constructions of the synchronization signal. For example, two copies of the same ZC sequence fit in a time-slot, one 127-length ZC sequence fits in a time-slot, or two same 63-length ZC sequences with two different roots fit into one time-slot. The detection performance of each combination could be different and would impact the number of copies to be transmitted to achieve acceptable detection performance.

In some examples, a design with two 63-length ZC sequence with two different roots is utilized; however, each ZC-sequence is deemed as one copy of the synchronization signal block even though the root of the sequences may not be the same. The remaining REs are either used for transmitting the reference signals that could be used for the data demodulation by the other UEs or they could be left as blanks since the receiver device do not require the reference signals during the resynchronization process. If a longer sequence (K>127) is used for the synchronization signal block, then a copy of the synchronization signal block is allocated multiple aggregated time-slots.

FIG. 4 is an example of a Frequency Division Duplex (FDD) deployment 400 in which a synchronization signal block is transmitted at a predetermined first time interval, Tₐ, before a time-slot in which RACH uplink transmissions are transmitted. In FDD deployments, the transmission of the synchronization signal block occurs in the downlink carrier, and the upcoming RACH resources are transmitted in the uplink carrier. As in the TDD deployments, the synchronization signal block is transmitted at a time interval, Tₐ, ahead of the upcoming RACH resources in the uplink carrier, which is known to the UEs.

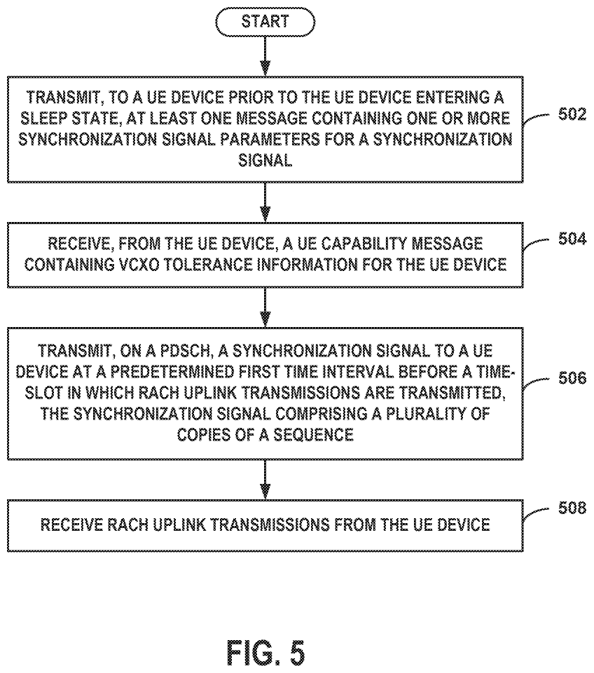

FIG. 5 is a flowchart of an example of a method in which a base station transmits synchronization signal parameters to a UE device before the UE device enters a sleep state. The base station transmits a synchronization signal to the UE device at a predetermined first time interval before a time-slot in which RACH uplink transmissions are transmitted. At step 502, a base station transmits, to a UE device prior to the UE device entering a sleep state, at least one message containing one or more synchronization signal parameters for a synchronization signal. At step 504, the base station receives, from the UE device, a UE capability message containing VCXO tolerance information for the UE device. At step 506, the base station transmits, on a PDSCH, a synchronization signal to the UE device at a predetermined first time interval before a time-slot in which RACH uplink transmissions are transmitted. The synchronization signal comprises a plurality of copies of a sequence. At step 508, the base station receives RACH uplink transmissions from the UE device.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A base station comprising:
a transmitter configured to transmit, on a Physical Downlink Shared Channel (PDSCH), a synchronization signal to a user equipment (UE) device at a pre-determined first time interval before a time-slot in which Random Access Channel (RACH) uplink transmissions are transmitted, the synchronization signal comprising a plurality of copies of a sequence.

2. The base station of claim 1, wherein the base station operates in accordance with a Time Division Duplex (TDD) deployment in which downlink resources and uplink resources are located on a same carrier.

3. The base station of claim 1, wherein the base station operates in accordance with a Frequency Division Duplex (FDD) deployment in which downlink resources are located on a downlink carrier and uplink resources are located on an uplink carrier.

4. The base station of claim 1, wherein the transmitter is further configured to transmit M×N copies of the sequence, where M represents a first number of copies of the sequence spread across at least a portion of downlink frequency resources utilized to transmit the synchronization signal and N represents a second number of copies of the sequence spread across at least a portion of downlink time resources utilized to transmit the synchronization signal.

5. The base station of claim 4, further comprising:
a controller configured to determine M and N based on at least one of the following: carrier bandwidth availability, a Coverage Enhancement (CE) level, a received downlink signal quality or strength reported by the UE device, and a Voltage-Controlled Crystal Oscillator (VCXO) tolerance of the UE device.

6. The base station of claim 1, wherein the transmitter is further configured to transmit, to the UE device prior to the UE device entering a sleep state, at least one message containing one or more synchronization signal parameters for the synchronization signal.

7. The base station of claim 6, wherein the transmitter is further configured to transmit the one or more synchronization signal parameters in at least one dedicated Radio Resource Control (RRC) message.

8. The base station of claim 6, wherein the transmitter is further configured to transmit the one or more synchronization signal parameters via Media Access Control (MAC) Control Element (CE) signaling.

9. The base station of claim 1, further comprising:
a controller configured to determine a projected wake-up time for the UE device,
wherein the transmitter is further configured to begin transmitting the synchronization signal during a second time interval that begins at the projected wake-up time.

10. The base station of claim 9, wherein the second time interval lasts for a period of time that is based, at least partially, on a clock-drift error value associated with the UE device.

11. The base station of claim 1, further comprising:
a receiver configured to receive a UE capability message containing Voltage-Controlled Crystal Oscillator (VCXO) tolerance information for the UE device; and
a controller configured to schedule transmission of the synchronization signal based, at least partially, on the VCXO tolerance information.

12. The base station of claim 1, wherein the transmitter is further configured to transmit the plurality of copies of the sequence in non-consecutive resources of the PDSCH.

13. The base station of claim 12, wherein the transmitter is further configured to transmit data for the UE device in time-frequency resources of the PDSCH that are interspersed between the non-consecutive resources of the PDSCH that are occupied by the plurality of copies of the sequence.

14. A user equipment (UE) device comprising:
a receiver configured to receive, on a Physical Downlink Shared Channel (PDSCH), a synchronization signal from a base station at a pre-determined first time interval before a time-slot in which Random Access Channel (RACH) uplink transmissions are transmitted, the synchronization signal comprising a plurality of copies of a sequence.

15. The UE device of claim 14, wherein the UE device operates in accordance with a Time Division Duplex (TDD) deployment in which downlink resources and uplink resources are located on a same carrier.

16. The UE device of claim 14, wherein the UE device operates in accordance with a Frequency Division Duplex (FDD) deployment in which downlink resources are located on a downlink carrier and uplink resources are located on an uplink carrier.

17. The UE device of claim 14, wherein the receiver is further configured to receive M×N copies of the sequence, where M represents a first number of copies of the sequence spread across at least a portion of downlink frequency resources utilized to transmit the synchronization signal and N represents a second number of copies of the sequence spread across at least a portion of downlink time resources utilized to transmit the synchronization signal.

18. The UE device of claim 14, wherein the receiver is further configured to receive, from the base station prior to the UE device entering a sleep state, at least one message containing one or more synchronization signal parameters for the synchronization signal.

19. The UE device of claim 18, wherein the receiver is further configured to receive the one or more synchronization signal parameters in at least one dedicated Radio Resource Control (RRC) message.

20. The UE device of claim 18, wherein the receiver is further configured to receive the one or more synchronization signal parameters via Media Access Control (MAC) Control Element (CE) signaling.

21. The UE device of claim 14, wherein the receiver is further configured to begin receiving the synchronization signal during a second time interval that begins at a projected wake-up time determined by the base station.

22. The UE device of claim 21, wherein the second time interval lasts for a period of time that is based, at least partially, on a clock-drift error value associated with the UE device.

23. The UE device of claim 14, further comprising:
a transmitter configured to transmit a UE capability message containing Voltage-Controlled Crystal Oscillator (VCXO) tolerance information for the UE device such that the base station schedules transmission of the synchronization signal based, at least partially, on the VCXO tolerance information.
